(19) United States
(12) Patent Application Publication
(10) Pub. No.: US 2019/0127065 A1
(43) Pub. Date: May 2, 2019

(54) BLADELESS UNMANNED AERIAL VEHICLE

(71) Applicant: INNERCO LLC, Corpus Christi, TX (US)

(72) Inventors: Austin CAPUNAY, Corpus Christi, TX (US); Daniel VALDENEGRO, Corpus Christi, TX (US); Daniel A. GONZALEZ MASSO, Corpus Christi, TX (US); Luis Rodolfo GARCIA CARRILLO, Corpus Christi, TX (US)

(21) Appl. No.: 16/007,854

(22) Filed: Jun. 13, 2018

Related U.S. Application Data
(60) Provisional application No. 62/580,391, filed on Nov. 1, 2017.

(51) Int. Cl. B64C 39/02; B64C 29/00

(52) U.S. Cl. CPC B64C 39/024; B64C 29/0075; B64C 2201/141; B64C 2201/162; B64C 2201/108

(57) ABSTRACT

A bladeless unmanned aerial vehicle includes a body and two or more thruster assemblies coupled to the body. The thruster assemblies each includes a ducted fan compressor and a discharge frame. The discharge frames may be bladeless fans or may be nozzles. The discharge frames may be positioned substantially vertically, tilted at an angle about an axis extending radially from the center of the body, and/or angled in a vertical plane aligned with an axis extending radially from the center of the body.

### CROSS-REFERENCE TO RELATED APPLICATIONS

This application is a non-provisional application which claims priority from U.S. provisional application No. 62/580,391, filed Nov. 1, 2017, which is incorporated by reference herein in its entirety.

### TECHNICAL FIELD/FIELD OF THE DISCLOSURE

The present disclosure relates to aerial vehicles and propulsions systems therefor.

### BACKGROUND OF THE DISCLOSURE

A large number of unmanned aerial vehicles (UAVs) are configured as multicopter airframes. Typical multicopters include a plurality of propellers designed to provide lift, propulsion, and attitude control of the UAV. However, the exposed propellers may cause safety problems for operators and others in the vicinity of the UAV. Propellers are also typically fragile and, due to their high rate of rotation during flight, may be easily damaged due to contact with environmental objects.

### SUMMARY

The present disclosure provides for an unmanned aerial vehicle (UAV). The UAV may include a body and two or more thruster assemblies each coupled to the body. Each thruster assembly may include a compressor. The compressor may be a ducted fan. Each thruster assembly may include a discharge frame. The discharge frame may be operatively coupled to the compressor and adapted to produce thrust by directing air supplied by the compressor in a direction opposite the desired thrust.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of a UAV consistent with at least one embodiment of the present disclosure.

FIG. 1A depicts a top view of the UAV of FIG. 1.

FIG. 2 depicts a side view of a thruster assembly consistent with at least one embodiment of the present disclosure.

FIG. 2A depicts a cross-section view of the thruster assembly of FIG. 2.

FIG. 2B depicts a cross-section view of a bladeless fan consistent with at least one embodiment of the present disclosure.

FIG. 2C depicts a detail cross-section view of a bladeless fan consistent with at least one embodiment of the present disclosure.

FIG. 3 depicts a top view of a bladeless fan consistent with at least one embodiment of the present disclosure.

FIG. 3A depicts a cross-section view of the bladeless fan of FIG. 3.

FIGS. 3B, 3C depict cross-section views of a bladeless fan consistent with at least one embodiment of the present disclosure.

FIG. 4 depicts a perspective view of the body of the UAV of FIG. 1.

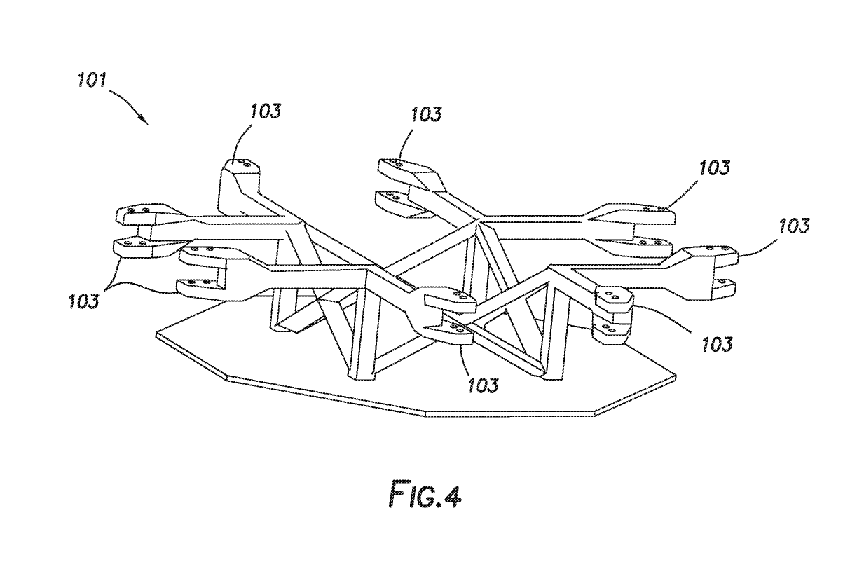

FIG. 5 depicts a perspective view of a UAV consistent with at least one embodiment of the present disclosure.

FIG. 5A depicts a perspective view of the body of the UAV of FIG. 5.

FIG. 5B depicts a top view of the UAV of FIG. 5.

FIG. 6 depicts a perspective view of a UAV consistent with at least one embodiment of the present disclosure.

FIG. 7 depicts a side view of a thruster assembly consistent with at least one embodiment of the present disclosure.

FIG. 8 depicts a perspective view of the body of the UAV of FIG. 7.

FIG. 9 depicts a schematic drawing of a multiple-compressor UAV consistent with at least one embodiment of the present disclosure.

FIG. 10 depicts a schematic representation of a single-compressor UAV consistent with at least one embodiment of the present disclosure.

FIG. 11 depicts a schematic representation of a controller for a UAV consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

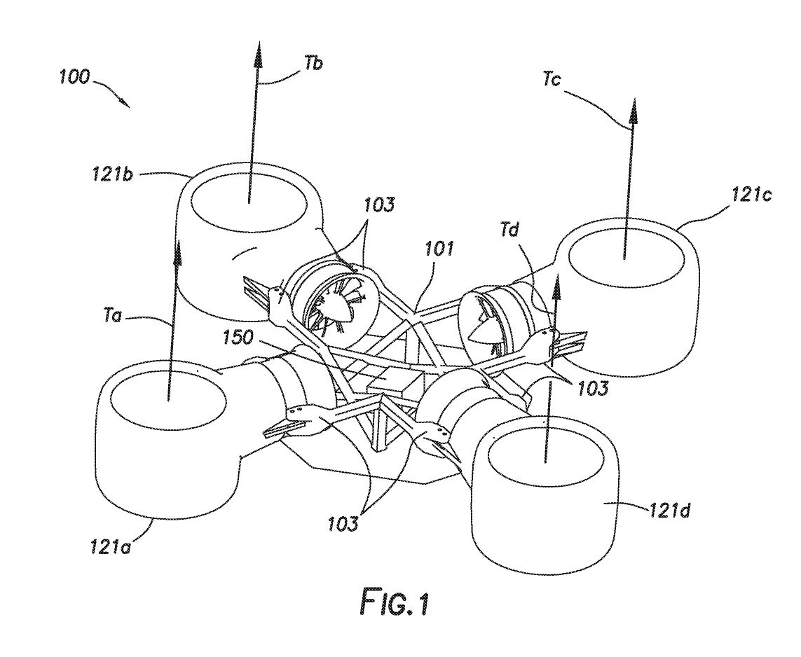

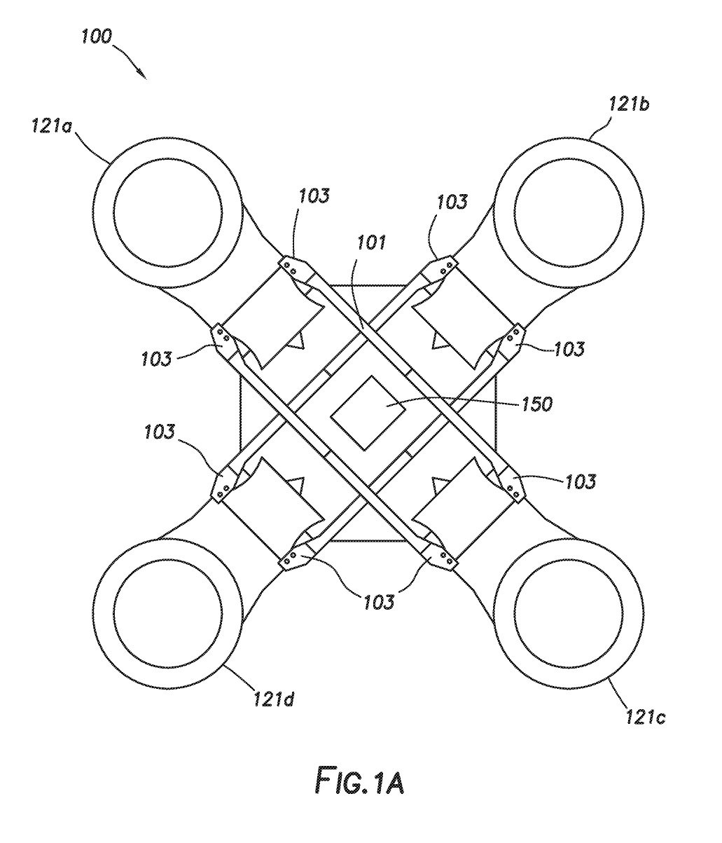

FIGS. 1 and 1A depict unmanned aerial vehicle (UAV) 100. UAV 100 may include body 101 and one or more thruster assemblies 121A-D. Although described herein as including four thruster assemblies, embodiments of the present disclosure may include any number of thruster assemblies more than one. Although depicted as being independent, thruster assemblies 121 may, in some embodiments, be operatively connected as further discussed below. In some embodiments, each thruster assembly 121 may mechanically couple to body 101 by one or more body attachment points 103 of body 101 as further discussed herein below. Body 101 may have any configuration designed to couple to and support thruster assemblies 121, controller 150 (further described below), and any payload to be carried by UAV 100 during operation. Body 101 may be constructed of any suitable material including, for example and without limitation, fiberglass, carbon fiber, aluminum, or titanium. The configuration depicted herein is not intended to limit body 101 in any way, and is merely shown as an example of a configuration of a body 101 consistent with embodiments of the present disclosure. In some embodiments, in which four thruster assemblies 121 are included, thruster assemblies 121 may be arranged in a cruciform pattern. Thruster assemblies 121 are adapted to provide thrust, designated as thrust T in FIG. 1, so as to provide lift and directional control to UAV 100 during flight.

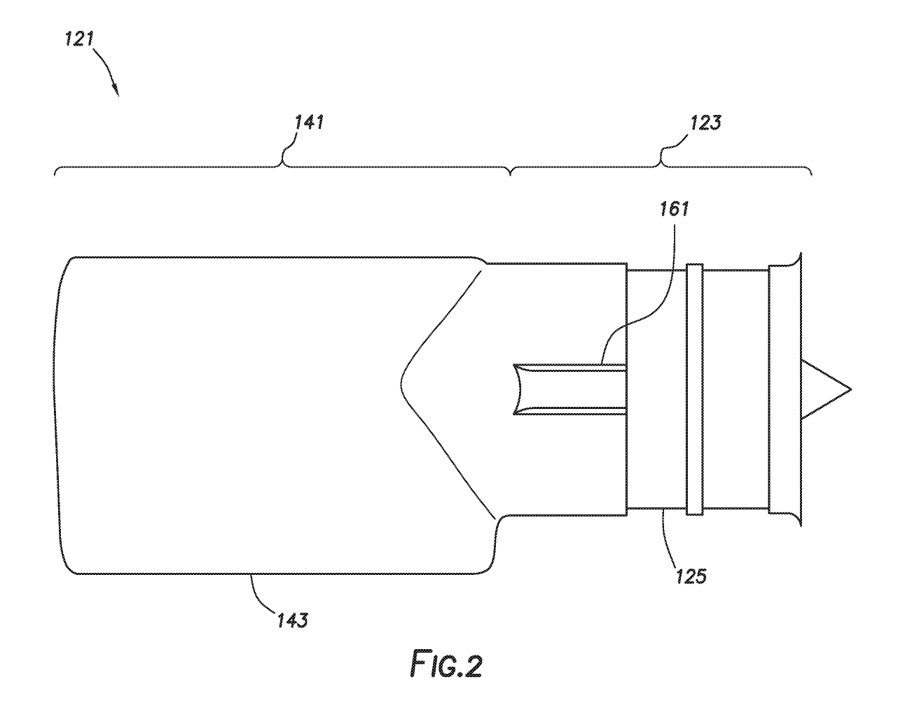

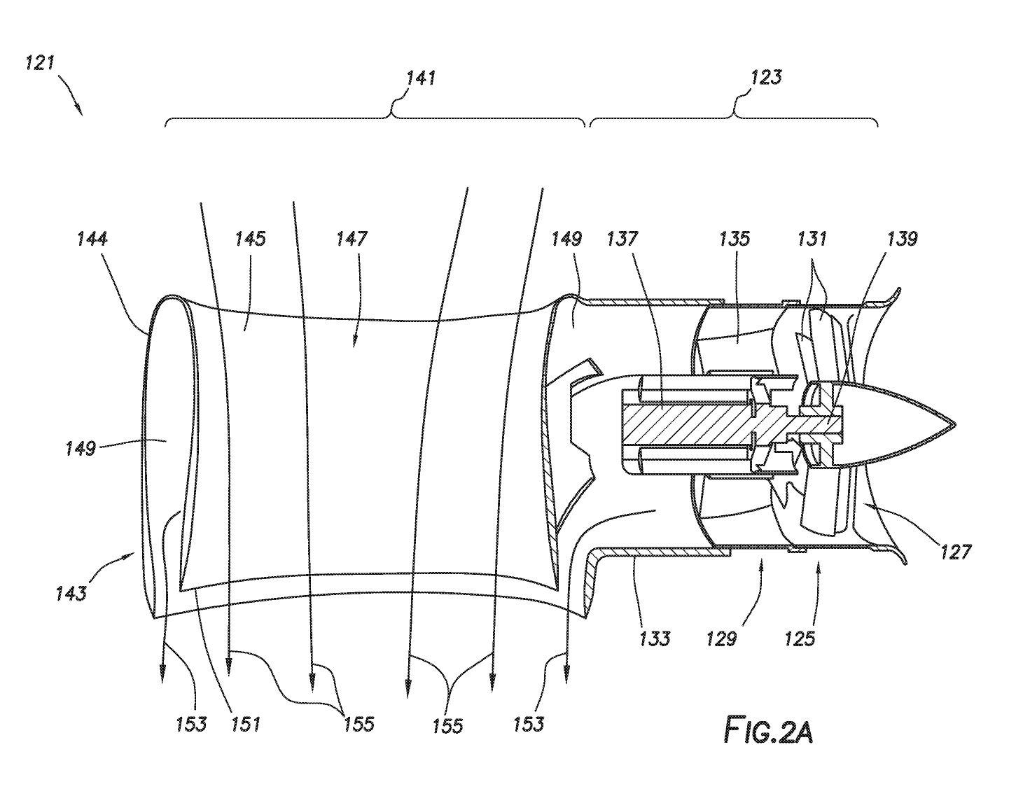

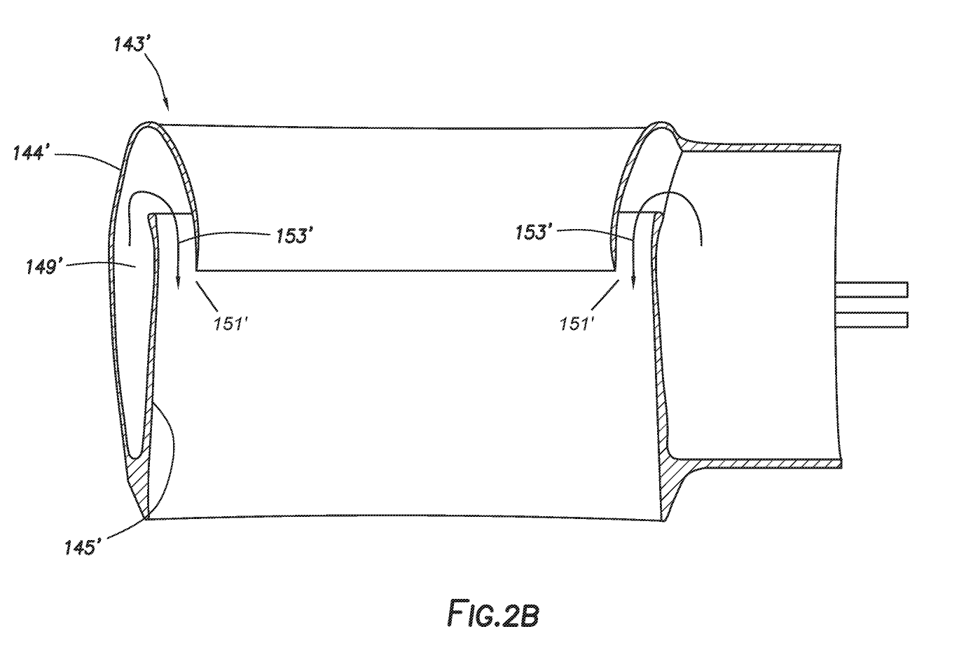

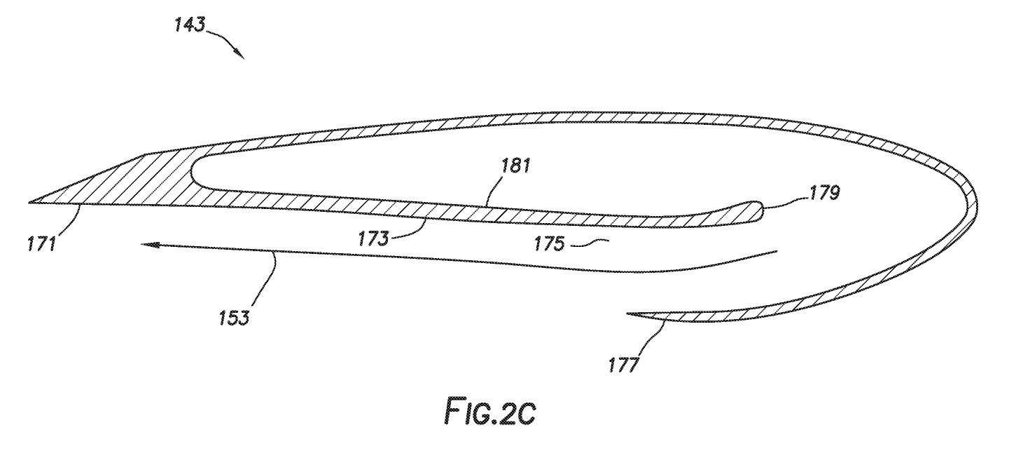

FIG. 2 depicts thruster assembly 121. Thruster assembly 121 includes compressor 123 and discharge frame 141. Compressor 123 may be any apparatus designed to provide high speed or high pressure air to discharge frame 141. In some embodiments, compressor 123 may include ducted fan 125. As shown in FIG. 2A, ducted fan 125 may include rotor 127 and stator 129. Rotor 127 may include one or more rotating fan blades 131 adapted to force air through compressor 123 toward discharge frame 141 through duct 133 as rotor 127 is rotated. In some embodiments, stator 129 may include duct 133 coupled to discharge frame 141. In some embodiments, stator 129 may include one or more supports 135 for rotatably supporting rotor 127 within stator 129. In some embodiments, compressor 123 may include motor 137 for driving rotation of rotor 127. Motor 137 may be mechanically coupled to supports 135. Motor 137 may couple to rotor 127 by shaft 139. Motor 137 may, in certain embodiments, be an electric motor such as, for example and without limitation, a brushless DC motor.

In some embodiments, discharge frame 141 may include bladeless fan 143. Bladeless fan 143 may be generally tubular in shape having outer surface 144 and inner surface 145 defining central passage 147. In some embodiments, without being limited to theory, bladeless fan 143 may be shaped such that high-speed or high pressure air from compressor 123 is ducted along inner surface 145 in the direction opposite the thrust desired to be produced by thruster assembly 121. In some embodiments, bladeless fan 143 may include interior passageway 149 through which supply air is ducted to injectors 151. Air flowing out of injectors 151 may pass along inner surface 145 of bladeless fan 143, defining primary airflow 153. In some embodiments, injectors 151 may be positioned at or near the bottom of inner surface 145 of bladeless fan 143 as shown in FIG. 2A. In some embodiments, as depicted in FIG. 2B, injectors 151′ may be positioned at or near the top of inner surface 145′ of bladeless fan 143′ and may be adapted to direct primary airflow 153′ exiting from interior passageway 149′ along inner surface 145′ of bladeless fan 143′. In some embodiments, inner surface 145 of bladeless fan 143 may be curved such that central passage 147 of bladeless fan 143 operates as a venturi, drawing additional air, defined as secondary airflow 155, through central passage 147 of bladeless fan 143 due to a low pressure effect caused by the high flow speed of primary airflow 153 along central passage 147 of bladeless fan 143. In some such embodiments, central passage 147 may be smoothly tapered to a narrow cross section at injectors 151, expanding smoothly below injector 151, causing a gradual compression and expansion of primary airflow 153 and secondary airflow 155 as it passes through central passage 147 of bladeless fan 143, thereby accelerating secondary airflow 155 using primary airflow 153.

In some embodiments, primary airflow 153 may substantially follow inner surface 145, without being bound to theory, by the Coanda effect. Secondary airflow 155 is drawn into central passage 147 of bladeless fan 143 and accelerated by primary airflow 153 such that primary airflow 153 and secondary airflow 155 are entrained and forced out of bladeless fan 143 in the direction opposite of the thrust produced by bladeless fan 143. In some embodiments, injectors 151 may be formed as a substantially continuous slot about inner surface 145 of bladeless fan 143. In some embodiments, injectors 151 may include multiple discrete apertures between interior passageway 149 and inner surface 145 of bladeless fan 143. In some embodiments, without being bound to theory, a smaller number of injectors 151 may generate higher flow rates from each injector at the cost of more turbulent airflow at higher Reynolds numbers, whereas a larger number of injectors 151 or continuous injectors 151 may result in primary airflow 153 being more homogeneous and at smaller Reynolds number.

In some embodiments, described with respect to FIG. 2C, the cross-sectional shape of bladeless fan 143 may be optimized to maximize the efficiency of bladeless fan 143. In some embodiments, the geometry of bladeless fan 143 may be described by trailing edge 171, high flow region 173, outlet 175, leading edge/outlet extension 177, inner leading edge 179, and inner surface of contact 181. Without being bound to theory, in some embodiments, it may be preferable that primary airflow 153 is laminar and includes minimal horizontal flow components along the thrust axis. In some embodiments, the angle of high flow region 173 may be modeled as an angle of attack. In some embodiments, higher angle of attack may result in a phenomena similar to a “stall” of high flow region 173 and the tra degree point where laminar flow becomes turbulent may be given as a function of airspeed. In bladeless fan 143, turbulent flow may result from a decrease in speed of flow or dispersion of primary airflow 153 along high flow region 173. By keeping primary airflow 153 laminar, a concentration of air flow, i.e. a nearly constant or uniform velocity along high flow region 173, may result in higher thrust. In some embodiments, the angle of high flow region 173 may be between 2 and 10 degrees.

In some embodiments, the combination of leading edge/outlet extension 177, inner leading edge 179, and inner surface of contact 181 may also affect the efficiency of bladeless fan 143. In some embodiments, inner surface of contact 181 may be at an angle to, for example and without limitation, reduce turbulence as air makes contact with inner surface of contact 181, therefore allowing the air to travel more efficiently along inner surface of contact 181 toward outlet 175. In some embodiments, leading edge/outlet extension 177 may include a curve that may contribute to a more efficient airflow towards outlet 175. In some embodiments, leading edge/outlet extension 177 may direct compressed air within the interior of bladeless fan 143 onto high flow region 173. In some embodiments, leading edge/outlet extension may be substantially parallel to high flow region 173 at outlet 175. In some embodiments, leading edge/outlet extension 177 may extend approximately a quarter of the length of high flow region 173.

In some embodiments, trailing edge 171 may transport airflow through bladeless fan 143 onto the surrounding medium. In some embodiments, trailing edge 171 may be designed to be as sharp as possible in order to, for example and without being bound to theory, avoid drag and sustain the flow of air in a single direction. In some embodiments, smooth or laminar airflow through bladeless fan between inner leading edge 179 and trailing edge 171 may allow for maximum thrust efficiency in one direction as opposed to having flow in multiple directions and reduced thrust.

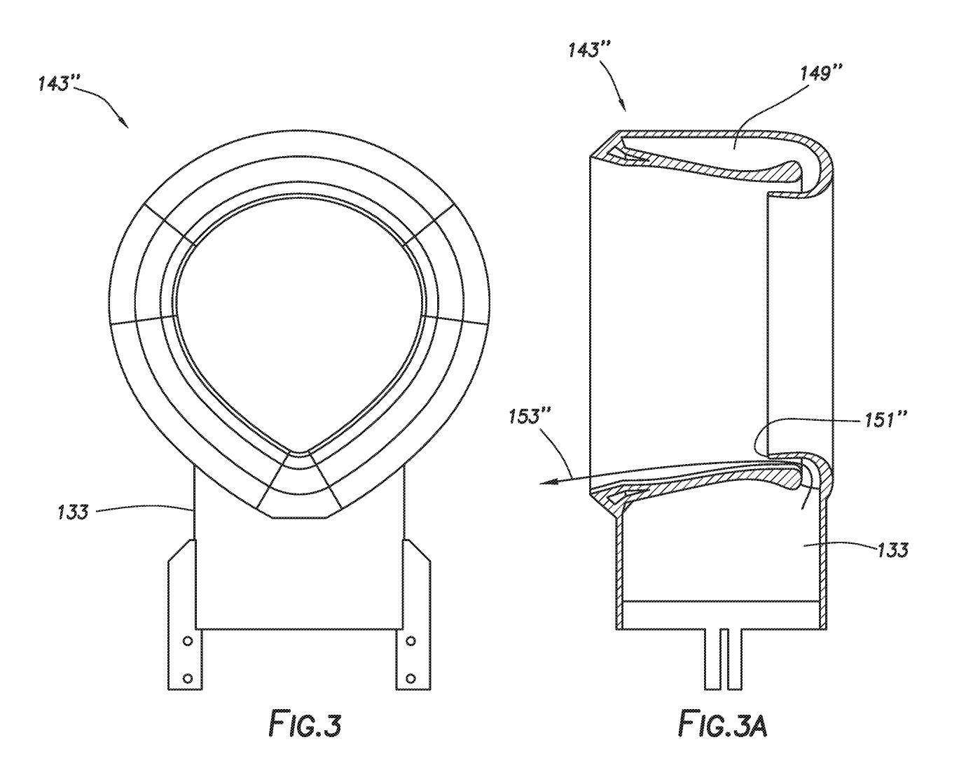

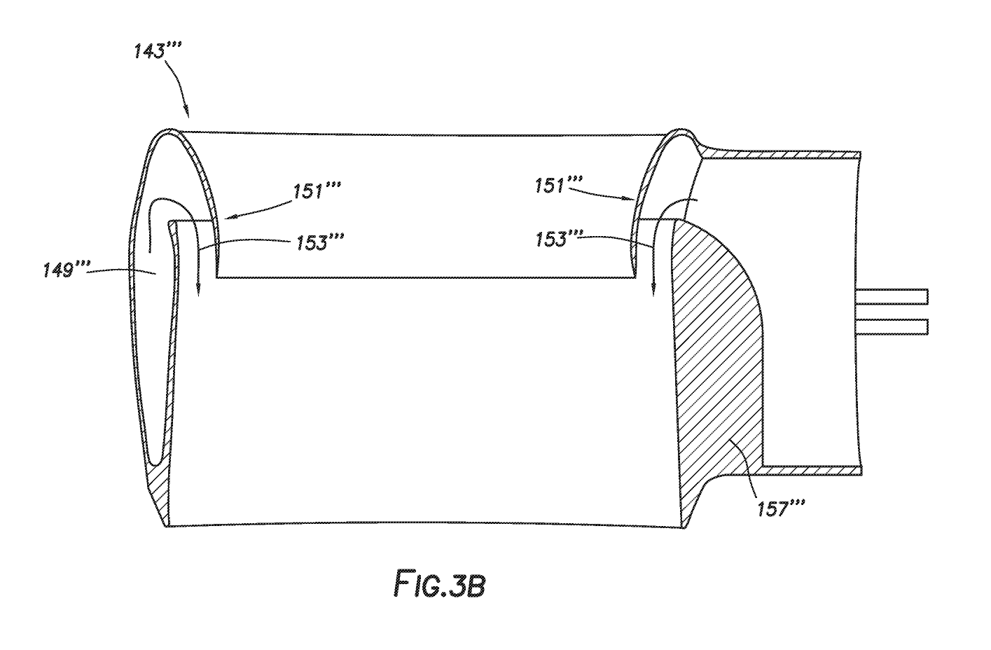

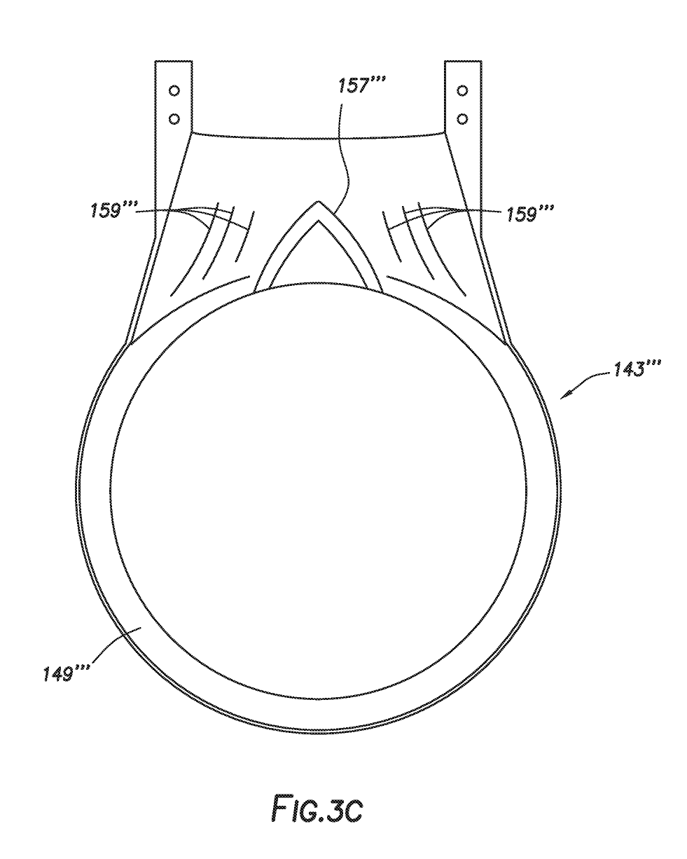

In some embodiments, as depicted in FIG. 1A, bladeless fan 143 may have a substantially circular cross-section in the lateral plane. In other embodiments, without limitation, bladeless fan 143 may have a noncircular cross-section such as “drop shaped” bladeless fan 143″ shown in FIGS. 3 and 3A. In such an embodiment, bladeless fan 143″ may allow faster air flow close to duct 133 within interior passageway 149″ of bladeless fan 143″, which may, for example and without limitation, lead to more homogeneity in primary airflow 153″ through injectors 151″ by maintaining more consistent pressure throughout interior passageway 149″ without requiring the use of baffles or other interior flow modifiers.

In some embodiments, as depicted in FIG. 3B, 3C, bladeless fan 143′ may include one or more interior flow modifiers such as diffuser 157′″. Diffuser 157″′ may, in some embodiments and without being bound to theory, increase pressure within bladeless fan 143″′ and reduce turbulence as air travels into interior passageway 149′″ of bladeless fan 143″′. In some embodiments, and without being bound to theory, diffuser 157′″ may also even out the airflow ejected from bladeless fan 143′″, leading to more homogeneity in primary airflow 153″′ through injectors 151″′ by maintaining more consistent pressure throughout interior passageway 149″′. In some embodiments, bladeless fan 143″′ may include one or more guider blades or vanes 159″′. Vanes 159″′ may, in some embodiments and without being bound to theory, guide the air within interior passageway 149′″ and into the exit of bladeless fan 143″′ and may reduce turbulence.

In some embodiments, as depicted in FIG. 2, thruster assembly 121 may include one or more thruster assembly attachment points 161. Thruster assembly attachment points 161 may be adapted to couple to corresponding body attachment points 103 of body 101. Thruster assembly attachment points 161 may mechanically couple to body attachment points 103 of body 101 by any suitable mechanism including, for example and without limitation, using one or more of threaded fasteners, snap-fit connections, interference fits, mechanical detents, or other mechanisms.

In some embodiments, as depicted in 1, 1A, and 4, body attachment points 103 may be positioned on body 101 at the same vertical position such that each thruster assembly 121a-d is coupled to body 101 such that the thrust Ta-d of each thruster assembly 121a-d is oriented vertically and mutually parallel. In such embodiments, pitch and roll control of UAV 100 may be provided by selectively varying the thrust Ta-d of each thruster assembly 121a-d in order to effect the desired change in attitude. In some embodiments, yaw control may be effected by varying the power supplied to each thruster assembly 121a-d. In such an embodiment, a subset of thruster assemblies 121a-d, such as thruster assemblies 121a and c, may be adapted such that the associated compressors 123 as previously described, rotate in a clockwise direction whereas the compressors 123 associated with thruster assemblies 121b and d rotate in a counter-clockwise direction, thereby imparting moments Ma-d on UAV 100. In such an embodiment, variation in the speed of rotation of compressors 123 of thruster assemblies 121a-d may cause moments Ma-d to unbalance when yaw is desired. Stable flight may be accomplished by varying the speed of rotation of compressors 123 of thruster assemblies 121a-d such that moments Ma-d are balanced.

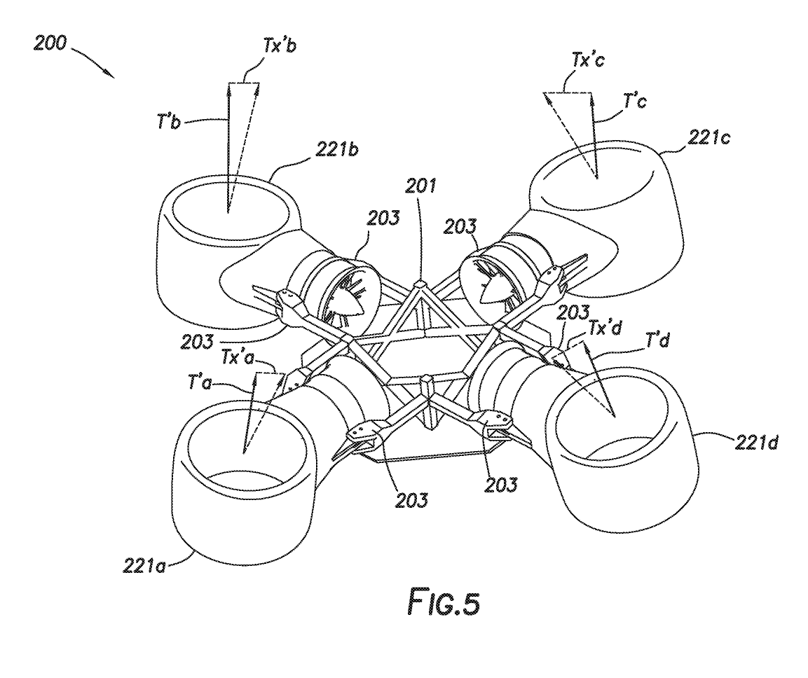

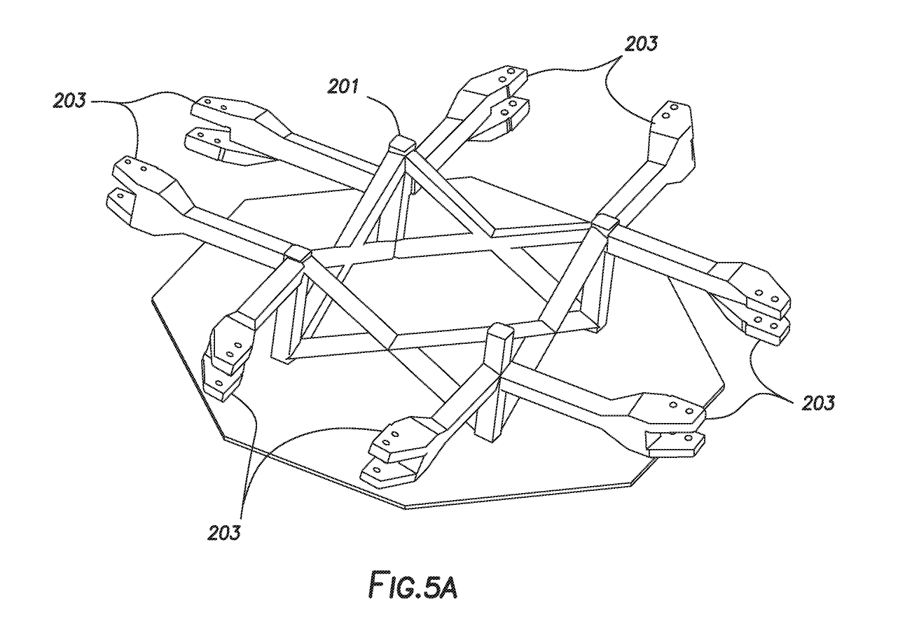

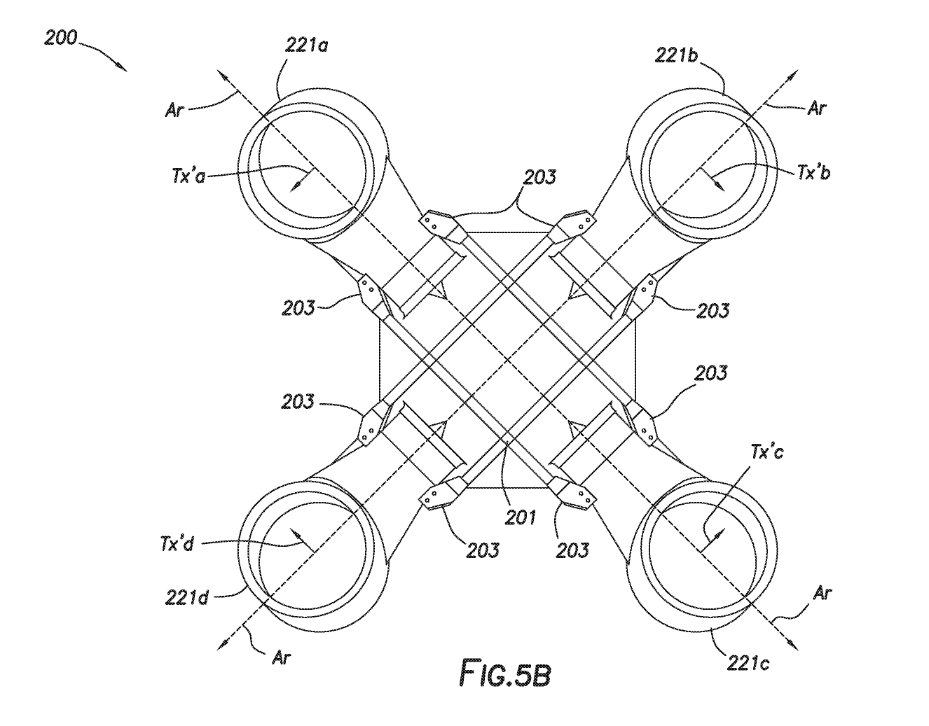

In some embodiments, as depicted in FIGS. 5, 5A, 5B, UAV 200 may include body 201 having body attachment points 203 positioned on body 201 at different vertical positions such that each thruster assembly 221aa-d is tilted from the vertical, rotated along an axis, Ar, extending radially from the center of UAV 200. In some embodiments, adjacent thruster assemblies 221a-d are tilted in the opposite directions such that opposite thruster assemblies (221a and 221c, 221b and 221d) provide thrust T′a and T′c, T′b and T′d in substantially parallel directions. In such an embodiment, pitch and roll control of UAV 200 may be provided by selectively varying the thrust T′a-d of each thruster assembly 221a-d as discussed above with respect to UAV 100 in order to effect the desired change in attitude. In some embodiments, yaw control may be effected by varying the power supplied to each thruster assembly 221a-d. In such an embodiment, yaw control may be effected by varying power supplied to opposite pairs of thruster assembly 221a and 221c, 221b and 221d such that horizontal components of thrust T′a-d, denoted as Tx′a-d substantially balance when no change in yaw is desired and are unbalanced when a yaw input is desired.

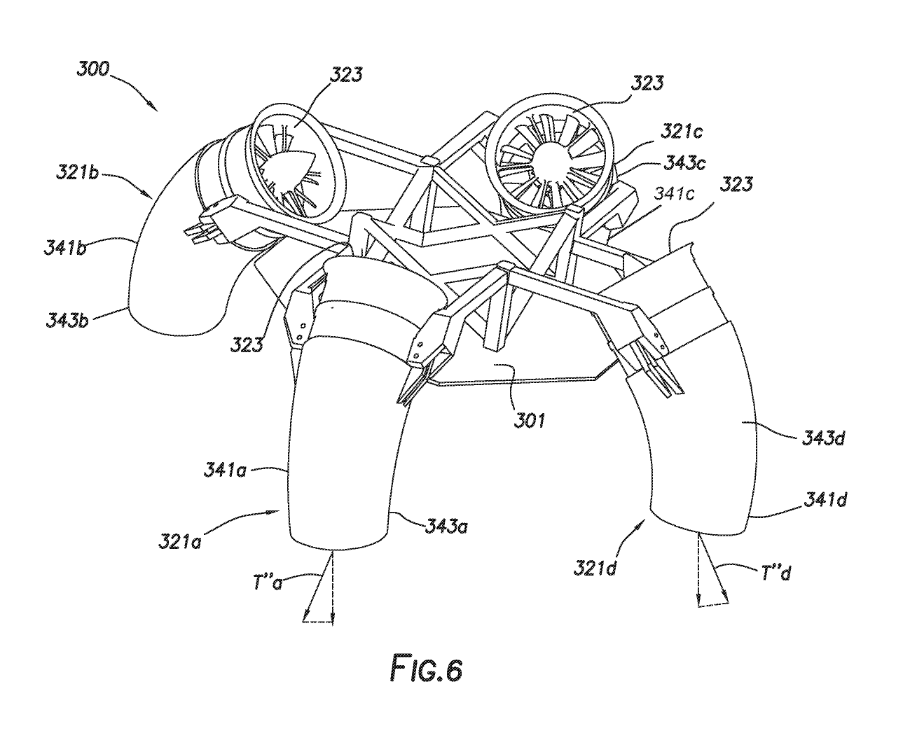

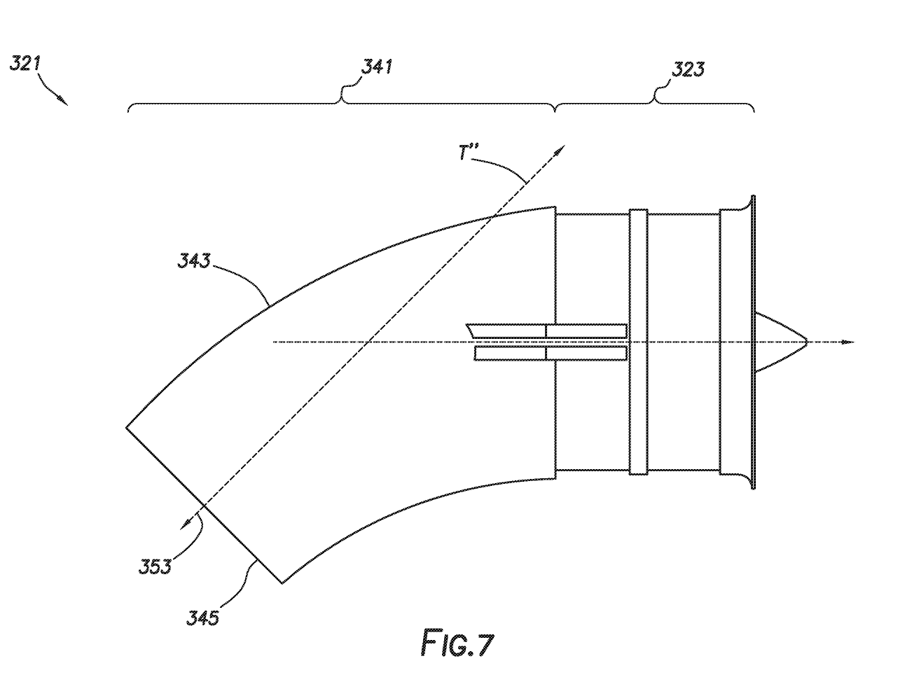

In some embodiments, as depicted in FIG. 6, UAV 300 may include body 301 and thruster assemblies 321a-d. In such an embodiment, thruster assemblies 321a-d may include compressors 323 and discharge frames 341a-d that include nozzles 343a-d. As depicted in FIG. 7, each nozzle 343 may be generally tubular and may couple to a corresponding compressor 323. Airflow from compressor 323 may be directed through nozzle 343. Nozzle 343 may be tapered such that the speed of the airflow increases as it passes through nozzle 343 before being released at nozzle end 345. In some embodiments, each nozzle 343 may include a bend of approximately 45° such that the thrust T″ produced by thruster assembly 321 extends at approximately 45° from the axis of compressor 323 as the airflow 353. In other embodiments, nozzle 343 may include no bend or may be bent up to 90°.

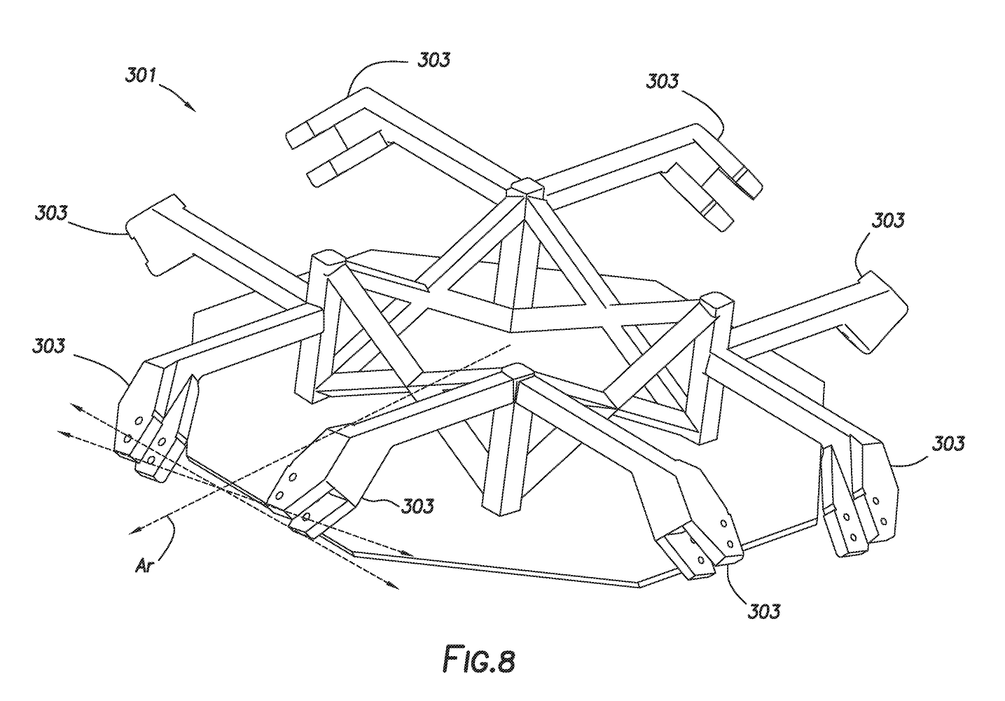

In some embodiments, body 301 may include body attachment points 303 positioned at the same vertical position such that each thruster assembly 321a-d is coupled to body 301 such that the thrust Ta-d of each thruster assembly 321a-d is oriented vertically and mutually parallel. In some embodiments, body 301 may include body attachment points 303 positioned on body 301 at different vertical positions such that each thruster assembly 321a-d is tilted from the vertical along an axis, Ar, extending radially from the center of UAV 300. In some embodiments, adjacent thruster assemblies 321a-d are tilted in the opposite directions such that opposite thruster assemblies (321a and 321c, 321b and 321d) are rotated along the radial axis and are substantially parallel with respect to such an axis. In some embodiments, as depicted in FIGS. 6, 8, where nozzles 343 include a bend angle below 90° or are straight, body attachment points 303 may be positioned at an angle in the vertical plane such that each thruster assembly 321a-d is angled in a vertical plane perpendicular to the radial axis Ar such that nozzles 343a-d are oriented such that each nozzle end 345, as discussed above, points substantially downward offset by the angle to which the respective thruster assembly 321a-d is angularly offset from the vertical as depicted in FIG. 6. For example and without limitation, in some such embodiments, nozzles 343a-d may include an approximately 45° bend, thruster assemblies 321a-d may couple to body 301 at approximately 45° from the vertical, and thruster assemblies 321a-d may be rotated along the radial axis Ar by approximately 5°-45°.

In such an embodiment, pitch and roll control of UAV 300 may be provided by selectively varying the thrust T″a-d of each thruster assembly 321 as discussed above with respect to UAV 100 in order to effect the desired change in attitude. In some embodiments, yaw control of UAV 300 may be effected by varying the power supplied to each thruster assembly 321a-d. In such an embodiment, a subset of thruster assemblies 321a-d, such as thruster assemblies 321a and c, may be adapted such that the associated compressors 323 as previously described, rotate in a clockwise direction whereas the compressors 323 associated with thruster assemblies 321b and d rotate in a counter-clockwise direction, thereby imparting moments M″a-d on UAV 300. In such an embodiment, because thruster assemblies 321 are angled vertically by, for example, 45°, variation in the speed of rotation of compressors 323 of thruster assemblies 321a-d may cause moments M″a-d to unbalance when yaw is desired. Stable flight may be accomplished by varying the speed of rotation of compressors 323 of thruster assemblies 321a-d such that moments M″a-d are balanced.

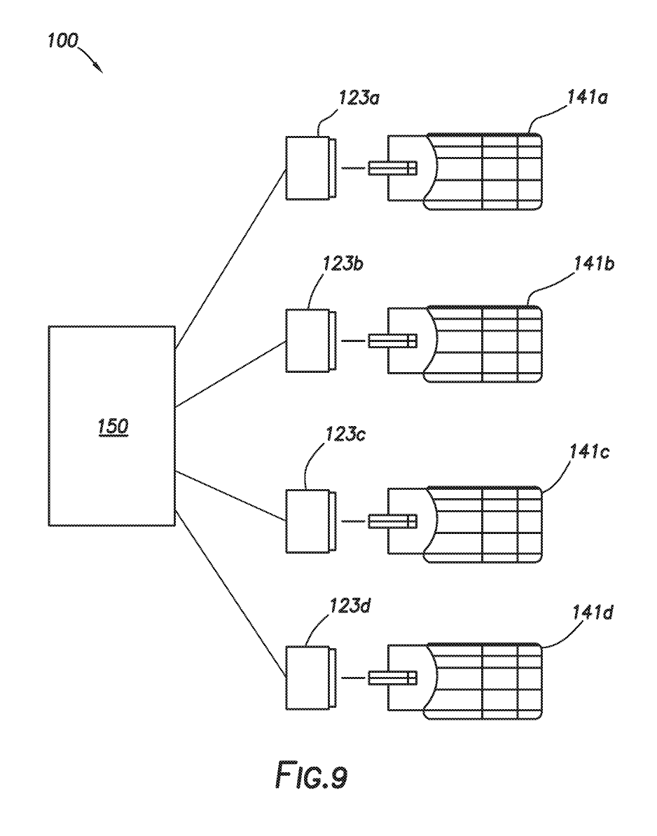

In some embodiments, as depicted schematically in FIG. 9, each thruster assembly 121a-d may include a dedicated compressor 123a-d coupled to discharge frame 141a-d of the respective thruster assembly 121a-d. In such an embodiment, controller 150 of UAV 100 may operate to control the rotation speed of each motor 137 of each thruster assembly 121a-d to control the flight of UAV 100. For example, altitude, pitch, roll, yaw, and thrust for movement may be controlled by varying the rotation speed of each motor 137 and therefore the thrust generated by the respective thruster assembly 121a-d may be varied by controller 150 directly.

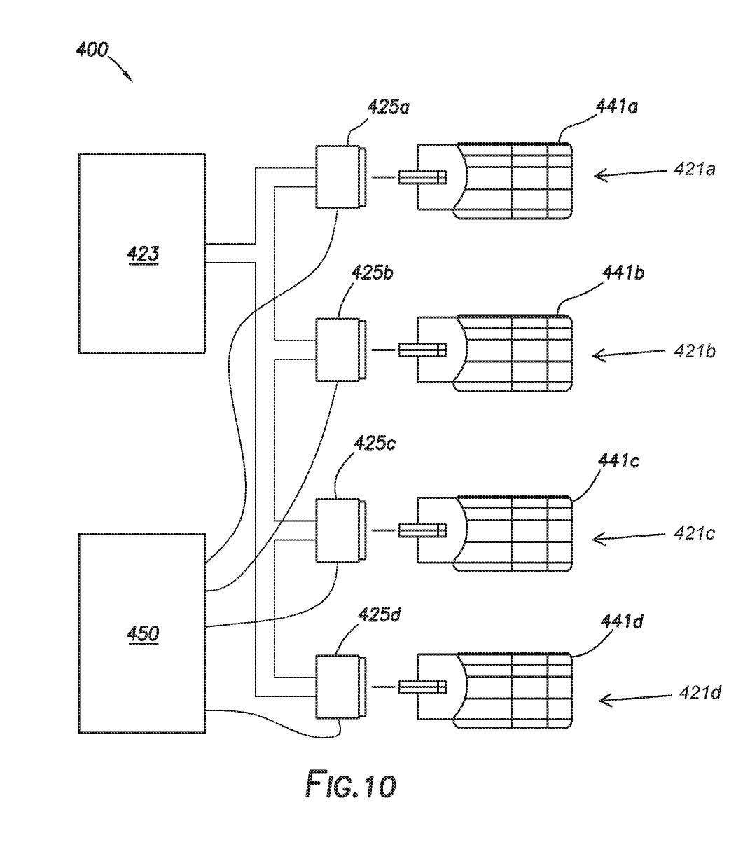

In some embodiments, as depicted schematically in FIG. 10, each thruster assembly 421a-d may be supplied air by a single compressor 423. In such an embodiment, the output of compressor 423 may be ducted to the discharge frame 441a-d of each thruster assembly 421a-d. In some embodiments, the flow to each discharge frame 441a-d may pass through a respective air regulator 425a-d positioned to modify the amount of air supplied to each discharge frame 441a-d. Controller 450 of UAV 400 may operate to control the amount of air supplied to each discharge frame 441a-d to control the flight of UAV 100. For example, altitude, pitch, roll, yaw, and thrust for movement may be controlled by varying the amount of air supplied to each discharge frame 441a-d and therefore the thrust generated by the respective thruster assembly 421a-d may be varied by controller 150.

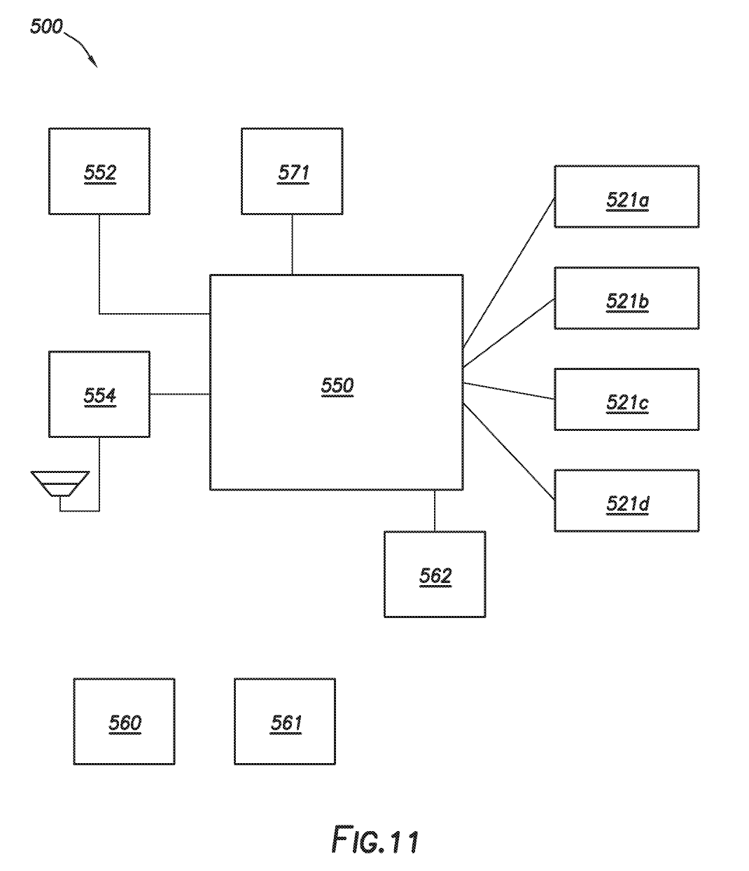

In some embodiments, as depicted schematically in FIG. 11, UAV 500 may include controller 550 adapted to provide directional control of UAV 500 as discussed above. In some embodiments, controller 550 may be operatively coupled to thruster assemblies 521a-d to control the thrust provided thereby as discussed by embodiments herein above. In some embodiments, controller 550 may include or be operatively coupled to one or more sensors 552. Sensors 552 may be used, for example and without limitation, to enhance stability of UAV 500 during flight, to provide autonomous or semiautonomous navigational capabilities to UAV 500, or otherwise assist controller 550 with controlling flight of UAV 500. Stability enhancement may include, for example and without limitation, accelerometers, gyroscopes, pressure transducers, magnetometers, or other sensors usable to determine variations in attitude of UAV 500 during flight, allowing controller 550 to, for example, maintain a predetermined attitude by measuring pitch, roll, yaw, or altitude changes. In some embodiments, sensors 552 for navigation may include, for example and without limitation, accelerometers, gyroscopes, and magnetometers for inertial guidance; global positioning system (GPS) or comparable technology receivers for satellite-based positioning; or other optical, acoustic, RADAR, or LIDAR sensors for providing navigational guidance. In some embodiments, controller 550 may operate in an autonomous mode, using sensors 552 and predetermined or received instructions to guide the flight of UAV 500. In some embodiments, controller 550 may operate in a semi-autonomous mode, using sensors 552 to manage certain aspects of the flight of UAV 500 while being commanded externally. In some embodiments, controller 550 may operate to translate such commands into specific actions of UAV 500 to operate as instructed. In some embodiments, controller 550 may operate only to translate external commands to desired actions of UAV 500.

In some embodiments controller 550 may include one or more communications systems 554 for receiving instructions from an external source such as transmitter 560. Instructions to be received by controller 550 may range from direct inputs for thrust levels of thruster assemblies 521a-d, direct instructions for movement of UAV 500, or instructions for the autonomous or semi-autonomous operation of UAV 500 by controller 550. In some embodiments, controller 550 may provide information to external receiver 561 including, for example and without limitation, measurements from sensors 552. For example, in some embodiments, in which sensors 552 include a camera, UAV 500 may transmit data from the camera to receiver 561 such that an image of what is seen by the camera can be reproduced by receiver 561. Communications system 554 may include any telemetry system for communicating with a remote transmitter 560 and/or receiver 561, including, for example and without limitation, radio frequency communications through point-to-point, satellite, or other infrastructure links.

In some embodiments, UAV 500 may include additional electronics or other equipment, referred to herein as payload 562. In some such embodiments, controller 550 may operate payload 562. In some embodiments, controller 550 may provide instructions to payload 562 based on predetermined criteria or based on instructions received from communications systems 554. In some embodiments, controller 550 may operate to receive information from payload 562 and transmit the information using communications systems 554 or may store the information for later recovery or for influencing future operation of UAV 500.

In some embodiments, UAV 500 may include one or more power supplies 571 for providing electricity to power components of UAV 500. Power supplies 571 may include a battery pack and associated charging components.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An unmanned aerial vehicle (UAV) comprising:
a body; and
two or more thruster assemblies each coupled to the body, each thruster assembly including:
a compressor, the compressor being a ducted fan; and
a discharge frame, the discharge frame operatively coupled to the compressor and adapted to produce thrust by directing air supplied by the compressor in a direction opposite the desired thrust.

2. The UAV of claim 1, wherein the thruster assemblies couple to the body at one or more corresponding body attachment points.

3. The UAV of claim 2, wherein the thruster assemblies are coupled to the body such that the thruster assemblies are substantially vertical.

4. The UAV of claim 2, wherein the thruster assemblies are coupled to the body such that the thruster assemblies are tilted about an axis extending radially from the center of the body.

5. The UAV of claim 2, wherein the thruster assemblies are coupled to the body such that the thruster assemblies are angled in a vertical plane aligned with an axis extending radially from the center of the body.

6. The UAV of claim 1, wherein the discharge frame comprises a bladeless fan.

7. The UAV of claim 6, wherein each bladeless fan is generally tubular and comprises an outer surface, an inner surface defining a central passage, an interior passageway, and one or more injectors, the injectors positioned to direct air supplied by the compressors to the inner surface of the corresponding bladeless fan.

8. The UAV of claim 7, wherein the bladeless fan comprises a single injector formed as a continuous slot.

9. The UAV of claim 7, wherein the bladeless fan comprises multiple injectors, wherein each injector is a discrete aperture between the interior passageway and the inner surface.

10. The UAV of claim 7, wherein the bladeless fan comprises a trailing edge, high flow region, outlet, leading edge/outlet extension, inner leading edge, and inner surface of contact.

11. The UAV of claim 10, wherein the trailing edge is formed as a sharp edge of the bladeless fan.

12. The UAV of claim 10, wherein the leading edge/outlet extension extends approximately one quarter of the length of the high flow region.

13. The UAV of claim 10, wherein the high flow region is at an angle of between 2 and 10 degrees.

14. The UAV of claim 10, wherein the leading edge/outlet extension is substantially parallel to the high flow region.

15. The UAV of claim 7, wherein the bladeless fan further comprises a diffuser positioned within the interior passageway, the diffuser positioned to reduce turbulence as air travels into the interior passageway from the compressor.

16. The UAV of claim 7, wherein the bladeless fan further comprises one or more guider blades or vanes positioned within the interior passageway, the guider blades or vanes positioned to guide the air within the interior passageway from the compressor to the injector.

17. The UAV of claim 1, wherein the discharge frame comprises a nozzle.

18. The UAV of claim 1, wherein each discharge frame is supplied with air by a single compressor.

19. The UAV of claim 18, wherein each discharge frame is coupled to the compressor by a flow regulator, each flow regulator adapted to modify the amount of air supplied to the corresponding discharge frame from the compressor.

20. The UAV of claim 19, further comprising a controller, the controller adapted to control each flow regulator.

21. The UAV of claim 1, wherein each compressor comprises a motor.

22. The UAV of claim 21, further comprising a controller, the controller adapted to control the speed of rotation of each motor.

23. The UAV of claim 1, further comprising a controller, the controller adapted to provide directional control of the UAV by controlling the thrust provided by each thruster assembly.

24. The UAV of claim 23, wherein the controller includes one or more sensors, the sensors including one or more of accelerometers, gyroscopes, pressure transducers, magnetometers, inertial guidance sensors, GPS receivers, optical sensors, acoustic sensors, cameras, RADAR systems, or LIDAR systems.

25. The UAV of claim 23, wherein the controller further comprises one or more communication systems for receiving instructions from an external source.

26. The UAV of claim 1, further comprising a power supply.
